(19) United States
(12) Patent Application Publication
(10) Pub. No.: US 2007/0061467 A1
(43) Pub. Date: Mar. 15, 2007

(54) Sessions and session states

(75) Inventors: Edward G. Essey, Seattle, WA (US); Alexei A. Levenkov, Kirkland, WA (US); Ranjan Aggarwal, Redmond, WA (US); Balbir Singh, Bellevue, WA (US); Adrienne G. Leavitt, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/227,550

(22) Filed: Sep. 15, 2005

(51) Int. Cl. G06F 15/16

(52) U.S. Cl. 709/227

(57) ABSTRACT

Systems and/or methods (“tools”) are described that enable application-specific session states in a single session, a network entity to be brought down without data loss, additional privacy for session states, continuity when a session state's version differs from that of the session state's network application, cessation of unnecessary roundtrips attempting to fetch session states, and other techniques. Some of these techniques may be enabled with a data structure having a single binary large object having application-specific identifiers for portions of the binary large object, version identifiers for those portions, a client token indicating the client associated with session states in the binary large object, and a session identifier indicating the session in which these session states exist.

### BACKGROUND

Currently, many users interact with network-enabled applications. A user on his home computer, for instance, may interact with a shopping-cart application to buy products over the Internet. If the user wants to select one product—a cookbook for instance—and then continue shopping for more products before buying the cookbook, the shopping-cart application will need to store that the user selected the cookbook. The user can then continue browsing and find another product to buy, such as a music CD. When the user goes to add the CD to the shopping cart, the shopping-cart application will show that the user still has the cookbook in the shopping cart. The user can then add the CD and purchase both.

For the shopping-cart application to keep track of the cookbook, it may use a “session state”. This session state contains information sufficient for the shopping-cart application to recreate the state of the shopping cart where the user left off.

Current network server systems maintain session states for network-enabled applications in various ways, each of which has potential problems. Some server systems store the session state on the user's computer—but this requires that the user's computer and the server system send the session state over a network, which can be slow and require significant network bandwidth. Some server systems use a server to maintain session states, but if that server fails, those session states may be lost. Another current server system uses front-end servers to execute applications and a database to maintain session states. Databases are generally less prone to failure than servers, thereby decreasing the chance that session states will be lost. But these systems are often tailored to one particular network-enabled application, which may limit their usefulness.

### SUMMARY

Systems and/or methods (“tools”) are described that enable application-specific session states in a single session, a network entity to be brought down without data loss, additional privacy for session states, continuity when a session state's version differs from that of the session state's network application, cessation of unnecessary roundtrips attempting to fetch session states, and other techniques. Some of these techniques may be enabled with a data structure having a single binary large object having application-specific identifiers for portions of the binary large object, version identifiers for those portions, a client token indicating the client associated with session states in the binary large object, and a session identifier indicating the session in which these session states exist.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIG. 1 illustrates an exemplary operating environment in which various embodiments can operate.

FIG. 2 is an exemplary process for enabling session-state continuity and other inventive techniques.

FIG. 3 illustrates an exemplary general identifier.

FIG. 4 is an exemplary process describing manners in which the tools store a session state and other information into a data structure.

FIG. 5 illustrates an exemplary data structure enabling access to multiple session states in a single BLOB.

FIG. 6 is an exemplary process for providing an application-specific session state and also describes other inventive techniques.

FIG. 7 is an exemplary process for ensuring privacy for session states.

FIG. 8 is an exemplary process for enabling version continuity for session states.

FIG. 9 is an exemplary process for enabling a system to avoid a roundtrip attempting to fetch a session state.

FIG. 10 is an exemplary process for enabling a server system to associate information and/or assign identifiers to a client or client request without a cookie or URL.

FIG. 11 is an exemplary process for enabling a server or application to be brought down without data loss.

The same numbers are used throughout the disclosure and figures to reference like components and features.

### DETAILED DESCRIPTION

Overview

The following document describes system(s) and/or method(s) (“tools”) capable of many powerful techniques, which enable, in some embodiments: application-specific session states in a single session, a network entity to be brought down without data loss, additional privacy for session states, continuity when a session state's version differs from that of the session state's network application, and cessation of unnecessary roundtrips attempting to fetch session states.

An environment in which these tools may enable these and other techniques is set forth first below. This is followed by others sections describing various inventive techniques and exemplary embodiments of the tools. One entitled Enabling Session-State Continuity describes exemplary ways in which the tools enable session-state continuity for a client interacting with a network-enabled application. Another entitled Providing an Application-Specific Session State describes a process for providing an application-specific session state and other inventive techniques. The next, entitled Privacy for Session States, describes an exemplary process for ensuring privacy for session states. Another is entitled Session State Versions and describes a process enabling version continuity for session states. The next is entitled Requests Not Needing a Session State, and describes a process for avoiding unnecessary roundtrips to fetch session states. Another is entitled Embedding Session Information in Post-Back Data and describes manners in which the tools associate session information in post-back information. The last, entitled Enabling an Entity to be Brought down without Data Loss, describes a system and method enabling a network entity to be brought down without losing data.

Exemplary Operating Environment

Before describing the tools in detail, the following discussion of an exemplary operating environment is provided to assist the reader in understanding one way in which various inventive aspects of the tools may be employed. The environment described below constitutes but one example and is not intended to limit application of the tools to any one particular operating environment. Other environments may be used without departing from the spirit and scope of the claimed subject matter.

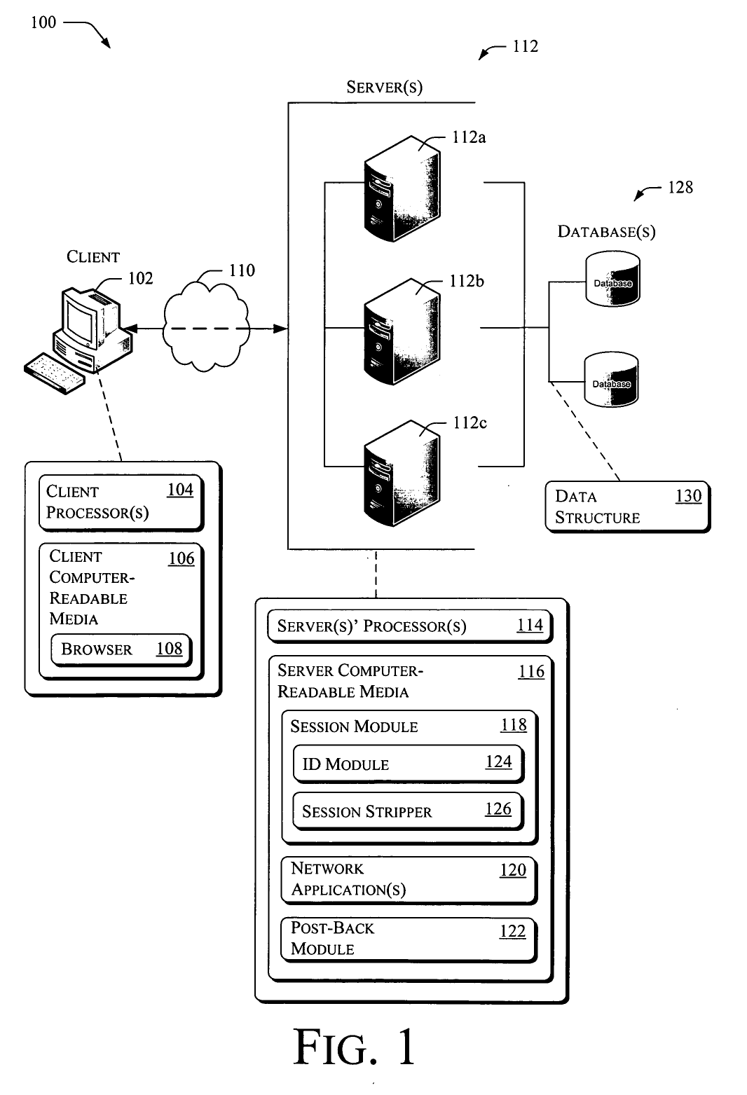

FIG. 1 illustrates one such operating environment generally at 100 comprising a client 102 having one or more client processor(s) 104 and client computer-readable media 106. The client comprises a computing device, such as a cell phone, desktop computer, personal digital assistant, or server. The processors are capable of accessing and/or executing the computer-readable media. The computer-readable media comprises or has access to a browser 108, which is a module, program, or other entity capable of interacting with a network-enabled entity.

The operating environment also comprises a network 110 and server(s) 112. The network enables communication between the client and the server(s), and can comprise a global or local wired or wireless network, such as the Internet or a company's intranet.

The server(s) comprise a single server or multiple servers, such as a server farm, though the server(s) may also comprise additional server or non-server entities capable of communicating with other entities or of governing the individual servers (e.g., for load balancing). The server(s) are shown with three separate servers 112a, 112b, and 112c operating serially or in parallel to service requests.

The server(s) comprise server(s)' processor(s) 114 and server computer-readable media 116. The server processor(s) are capable of accessing and/or executing the server computer-readable media. The server computer-readable media comprises or has access to a session module 118, network application(s) 120, and a post-back module 122. The server computer-readable media may also comprise an ID module 124 and an session stripper 126. These are shown comprised by session module 118, though they may also be separate. The ID module and session stripper may act separately or in concert with the session module and/or each other. The server(s) are shown comprising each of these elements, though these elements may be spread over individual servers or other entities comprised by server(s) 112, such as another computing device that acts to govern the individual servers 112a, 112b, and 112c.

The operating environment also comprises database(s) 128 having a data structure 130. The server(s) are capable of communicating with the database(s) to gain a session state useful in enabling client 102 to maintain logical continuity with a network application.

Enabling Session-State Continuity

The following discussion describes exemplary ways in which the tools enable session-state continuity for a client interacting with a network-enabled application. This discussion also describes ways in which the tools perform other inventive techniques as well.

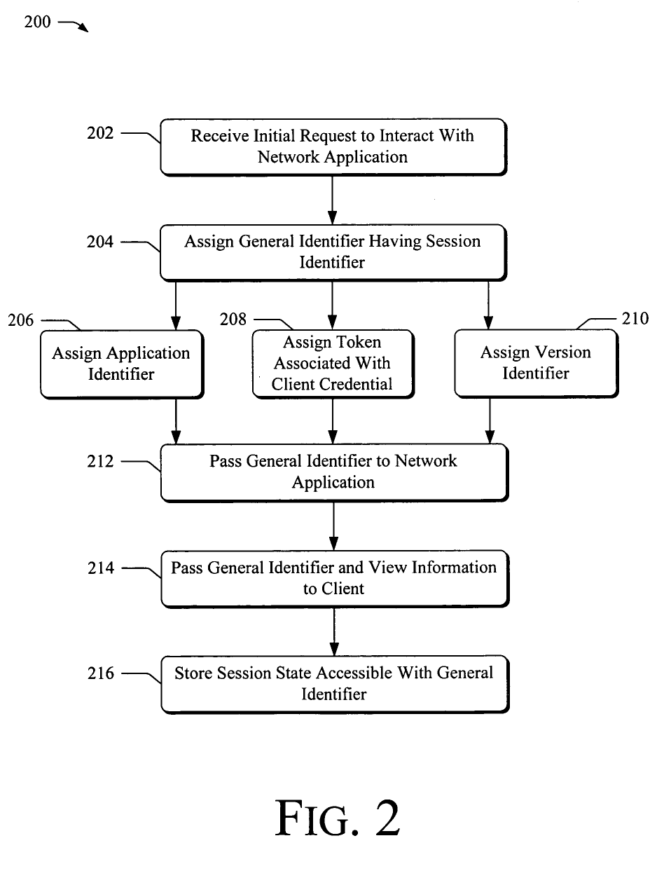

FIG. 2 is an exemplary process 200 enabling session-state continuity and other inventive techniques. It is illustrated as a series of blocks representing individual operations or acts performed by elements of operating environment 100 of FIG. 1, such as session module 118. This and other processes disclosed herein may be implemented in any suitable hardware, software, firmware, or combination thereof; in the case of software and firmware, these processes represent a set of operations implemented as computer-executable instructions stored in computer-readable media and executable by one or more processors.

Block 202 receives an initial request to interact with an application. This request may be to begin a session that may need information continuity, such as through maintenance of a session state.

In an illustrated embodiment, the request is one necessitating a new session and a new session state. Here the request is received by session module 118 from client 102 using browser 108 and across network 110. By way of example, assume that the request is to interact with network application 120 to open a new instance of a network form for entering a user's address.

Block 204 assigns a general identifier for a new session. This general identifier comprises a session identifier having information sufficient to enable a session to later be identified, such as for a subsequent request needing a session state associated with the session.

In some embodiments, block 204 assigns a general identifier having one or more identifiers in addition to the session identifier. These alternative embodiments are shown at block 206, 208, and 210. Any combination or none of these blocks may be performed.

Block 206 assigns an application identifier enabling later access to an application-specific session state. This identifier and how it may be used are described in greater detail below.

Block 208 assigns a token associated with a client or user credential. The token enables a session or session state to be uniquely related to a user or client, thereby permitting the tools to prohibit access to a session state that is requested by a user or client other than the user or client for which the session state was created. This can help server(s) maintain a user's privacy. If a user enters data into a form over the network with his or her name and credit card number, for instance, another person may be prohibited from opening that form with the user's name and credit card number in the form even if the other person submits the session identifier. Without the user's session state, which has the user's name and credit card, a network application will generally open a blank form for another user or not open the form at all.

Block 210 assigns a version identifier capable of identifying a version of a session state. This identifier and how it may be used are described in greater detail below.

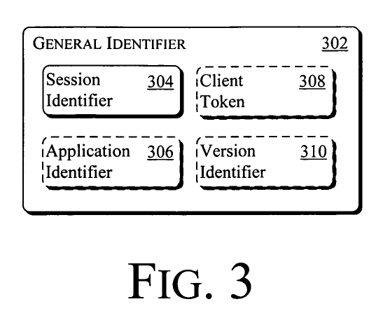

In the ongoing embodiment, blocks 206, 208, and 210 are performed resulting in a general identifier having a session identifier, an application identifier, a token, and a version identifier. An example of such a general identifier is shown in FIG. 3. Here general identifier 302 comprises session identifier 304, application identifier 306, client token 308, and version identifier 310. In one embodiment, the session identifier is assigned by session module 118 and the other identifiers are assigned by ID module 120, which may act independently or dependently with the session module.

The general identifier assigned at block 204 and any of subsequent blocks 206-210, can be assigned as a cookie or Universal Resource Locator (URL). Here the general identifier is assigned in the form of a cookie.

Block 212 passes the general identifier to the network application. Here session module 118 passes general identifier 302 to network application 120 along with the request to open a new electronic form for entry of a user's address. The network application then sends viewing information to the session module for communication to the client. Using this viewing information, browser 108 may present a user interface in which the user may enter his or her address. Here the viewing information is in the form of a markup language, such as HyperText Markup Language (HTML).

Block 214 passes the general identifier and the viewing information to the client. The general identifier may be passed in the form of a cookie, as set forth above. In an exemplary embodiment, however, the general identifier is passed in a form usable by a client that does not accept cookies and not as a URL. A section entitled Embedding Session Information in Post-Back Data describes this exemplary embodiment in greater detail.

With this view information the user (here through browser 108) can enter data, such as a selection to purchase a product or his or her address. Assume for example, that the user enters “Jane Doe” and “123 W. American Ave.” into an electronic form through browser 108. The network application, once the data is received, can add the user data to a session state. The session state can comprise the user data and other information useful in providing continuity for a user.

Block 216 stores a session state reflecting the client's interaction with the network application that is accessible with the general identifier. Here the session state is stored in database(s) 128 of FIG. 1. The session state can be stored in a single serialized Binary Large Object (BLOB) in the databases or otherwise. An exemplary data structure and method for building the data structure is set forth immediately below. This data structure enables storage and access of multiple session states in a single BLOB, in addition to other inventive techniques.

Exemplary Data Structure

In some embodiments, the session state is stored in a data structure enabling storage and access of multiple session states in a single BLOB. By so doing, session states for multiple applications or application instances may be accessed as part of a single session.

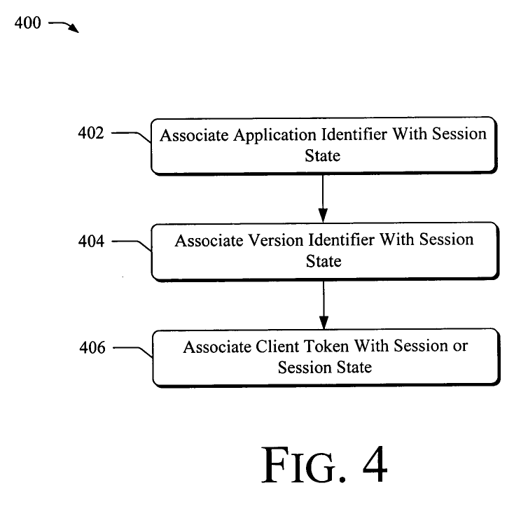

FIG. 4 is an exemplary process 400 describing exemplary manners in which the tools store a session state and other information into a data structure. It is illustrated as a series of blocks representing individual operations or acts performed by elements of operating environment 100 of FIG. 1, such as session module 118. Process 400 may act in conjunction with or be an implementation of block 216 of process 200 or may act independently of process 200.

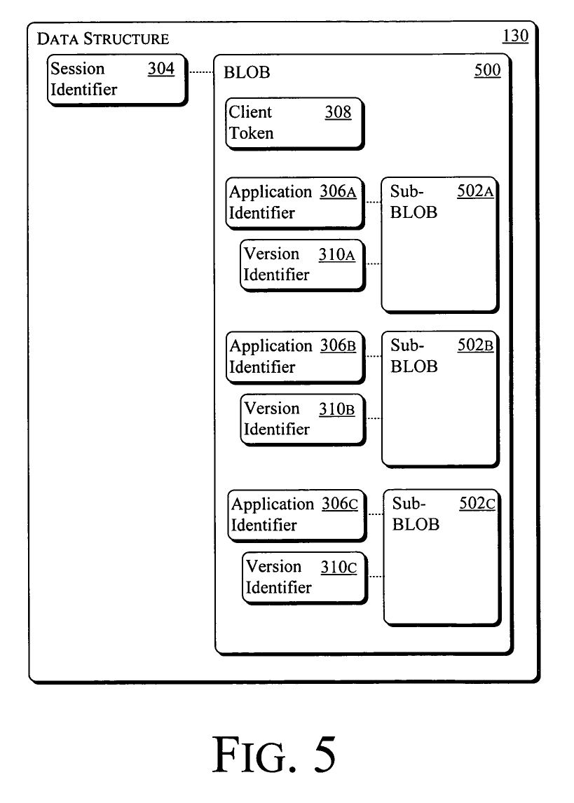

Block 402 associates an application identifier with a session state in a data structure. An exemplary data structure 130 enabling access to multiple session states in a single BLOB 500 is shown in FIG. 5. Here session module 118 stores the session state into a sub-BLOB 502a of BLOB 500. The session module may do so multiple times for different applications or instances, thereby storing multiple session states, here in sub-BLOB 502b and 502c. Each of these session states can be created as part of a single session.

The application identifier can be associated with the sub-BLOB (and thus the session state) with a namespace. BLOB 500 may comprise a hierarchical structure or otherwise, so long as it and/or data structure 130 permits multiple session states to be stored and accessed.

Data structure 130 also comprises two other sub-BLOBs 502b and 502c, along with other application identifiers 306b and 306c, respectively. These represent other session states for either other applications or other instances of an application. With these multiple session states, a single client may interact with multiple applications or instances in a single session. A user no longer has to open a new session to interact with a different application or instance, such as a shopping-cart application on ACME.com and an application for entering a product review also on ACME.com.

If a client requests to interact with another application or instance of an application as part of the same session, for instance, the tools may store and enable access of these other session states, e.g., those in sub-BLOBs 502b and 502c. Process 200 may act to assign general identifiers for each session state having a same session identifier, different application identifiers, different version identifiers (if applicable), and a same client token (if performed). In so doing, many general identifiers may be created and usable to access different session states in a data structure such as data structure 130 shown in FIG. 5. Also, when a client creates or interacts with one session state in a session, other session states in that session need not be affected.

Block 404 associates a version identifier with a session state. This is shown in the exemplary data structure with each sub-BLOB 502a, 502b, and 502c having version identifier 310a, 310b, and 310c, respectively. By so doing, a session state retrieved from the BLOB may indicate the version of the network application that created the session state (or the version of the session state itself). If the version of the network application or server has been upgraded since the session state was created, the network application may determine that the received session state is an older version. Based on this determination, the tools (e.g., upgrade module(s) related to the network application) may upgrade the session state to permit its use by the newer version of the network application. In many instances, this ability permits an administrator to upgrade a network application without shutting down current sessions having session states or causing those session states to be invalid when later accessed.

Block 406 may associate a client token with the session or session state. This is shown with inclusion of client token 308 in BLOB 500. The client token enables the tools to differentiate between clients. By so doing, the tools (e.g., session module 118) may refuse to enable a client to access a session state that he or she did not create. Here the session module stamps the BLOB with the client token as a post-serialization event.

With these session states so stored, the tools may provide multiple, application-specific session states to a client as part of the same session. This permits the tools to enable a user to interact with multiple applications or application instances in a single session.

Providing an Application-Specific Session State

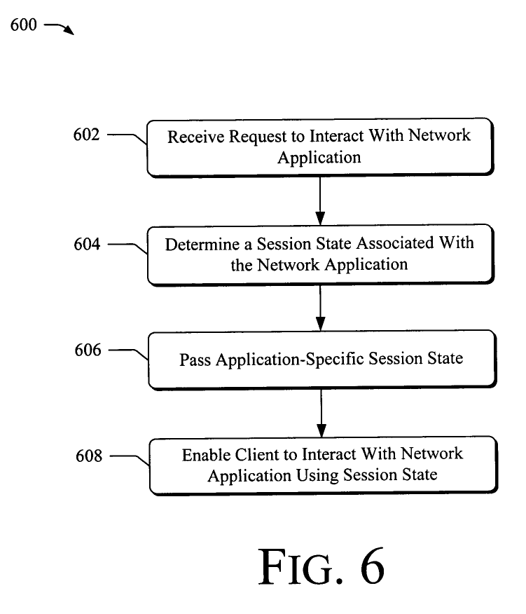

FIG. 6 is an exemplary process 600 for providing an application-specific session state and also describes other inventive techniques. It is illustrated as a series of blocks representing individual operations or acts performed by elements 19 of operating environment 100 of FIG. 1, such as session module 118. This process may use, in some embodiments, identifiers and session states created as part of process 200 of FIG. 2 and/or process 400 of FIG. 4.

Block 602 receives a request to interact with a network application having a session state. Here we assume that session module 118 receives a request from client 102 having the general identifier described as part of FIGS. 2 and 3, and thus to continue to fill out the address form.

Block 604 determines, based on the application identifier, a session state associated with a particular application or application instance. Here session module 118 fetches BLOB 500 for the session identifier in a serialized form based on the session identifier received in the general identifier. The session module then de-serializes the BLOB into a single object containing all of sub-BLOBs 502a, 502b, and 502c. Based on the application identifier, the session module determines which part of the BLOB contains the session state for that application identifier, here with the application identifier 306a stored in a namespace for sub-BLOB 502a. If the other application identifiers 306b or 306c are for the same network application but a different instance (e.g., a different electronic form enabled by the same network application), the session module may determine this based on the application identifier having a different instance identifier.

Block 606 passes a session state specific to an application or application instance to the correct network application. By so doing, the network application or its instance may not need to understand session states of other instances or applications. This permits network applications used in accord with the tools to be programmed more easily, in many cases, than network applications needing to understand session states of other, disparate applications.

Block 608 enables the client to continue interacting with the network application with the correct session state. Here network application 120 receives the correct session state for the address form having the user entered data of “Jane Doe” and “123 W. American Ave.” and enables the user to continue entering data and/or submit the data in the form.

Privacy for Session States

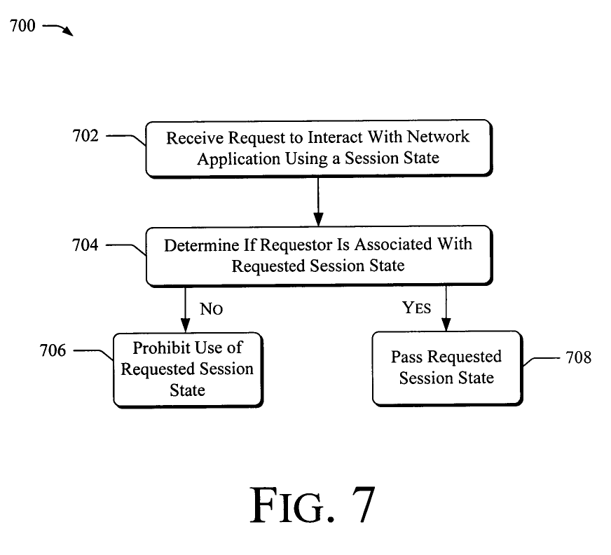

FIG. 7 is an exemplary process 700 for ensuring privacy for session states. It is illustrated as a series of blocks representing individual operations or acts performed by elements of operating environment 100 of FIG. 1, such as session module 118. This process may use client tokens and session states created as part of process 200 of FIG. 2 and/or process 400 of FIG. 4.

Block 702 receives a request to interact with a network application using a particular session state. This particular, requested session state can be indicated in the request using the session identifier described above, for instance. Assume, by way of example, that the request comprises a session identifier and a client credential indicating the identity of a user or the user's machine (e.g., client computer).

Block 704 determines whether or not the requestor is associated with the requested session state. The requester may, for instance, be malevolent code or person wishing to gain access to a user's data in a session state. Here assume that the requestor sends a session identifier matching session identifier 304 assigned by the tools at process 200. Assume also that the requestor sends a client credential indicating the identity of the client. Block 704 may determine whether the particular session state requested (here in sub-BLOB 502a of FIG. 5) was created for that requester. If the credential matches a client token (here client token 308 of FIG. 3) associated with the received credential, block 704 determines that the requestor is associated with the particular session state. If not, block 704 determines that it is not.

The session state need not be stored in sub-BLOB 502a or be part of a data structure enabling multiple session states for a single session. It may also be a single session state in a single session. In either case, the tools may determine whether or not to enable a network application to use the requested session state.

Continuing the prior embodiment of process 200, session module 118 receives a serialized BLOB 500 having embedded client token 308. Session module 118 gains client token 308 embedded in the BLOB. The session module then compares a client credential previously associated with client token 308 with a client credential received with the current request of block 702. If the credentials do not match, the session module does not send the requested session state to a network application (e.g., does not de-serialize the BLOB).

Block 706 prohibits access to or does not enable use of the requested session state if the requestor is not shown to match the user or client for which the session state was created.

Block 708 passes the requested session state to the appropriate network application if the requestor is shown to match the user or client for which the session state was created.

Session State Versions

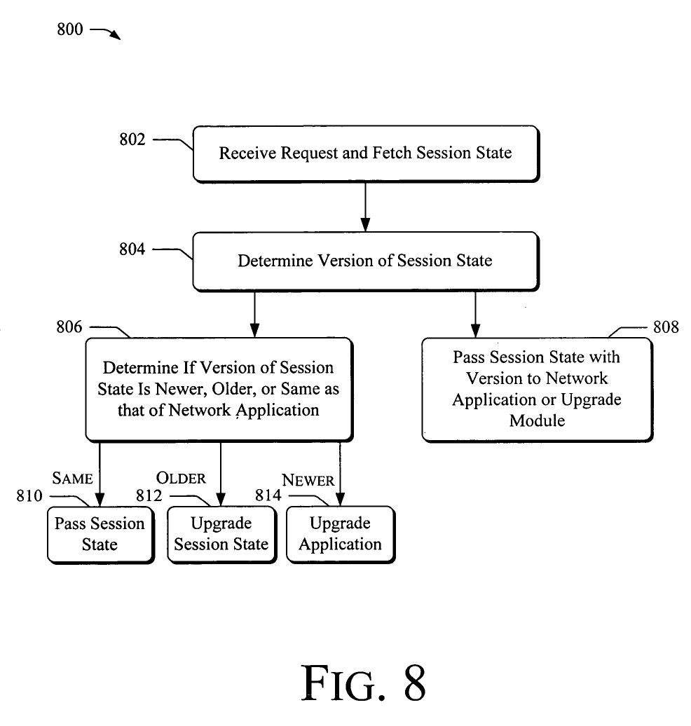

FIG. 8 is an exemplary process 800 for enabling version continuity for session states. It is illustrated as a series of blocks representing individual operations or acts performed by elements of operating environment 100 of FIG. 1, such as session module 118. This process may, in some embodiments, use version identifiers and session states created as part of process 200 of FIG. 2 and/or process 400 of FIG. 4, such as version identifiers created at block 404 and shown in FIGS. 3 and 5.

Block 802 receives a request for a session state and fetches that session state. Block 802 may do so following similarly to blocks 602 and 604 of FIG. 6 or otherwise.

Block 804 determines a version of the session state. The version of the session state may be indicated with an identifier, such as version identifier 310 of FIG. 3. Here assume that a user is attempting to interact with the address form used as an example above. The session state for the address form has the user's previously entered data in it (“Jane Doe” and “123 W. American Ave.”). Assume also that the tools assigned version identifier 310a to sub-BLOB 502a, thereby associating a version with the session state of the sub-BLOB. Session module 118 may then determine the version of the session state fetched at block 802 based on the version identifier. At this point the tools may proceed to determine if the version for the session state is newer, the same, or older than the network application that uses the session state (block 806). Or, the tools may pass the session state to the network application or an upgrade module with an indication of the version (block 808).

Block 806, as mentioned, determines whether the version for the session state is the same, newer, and/or older than that of the network application to which the session state will be passed. The tools may do so by communicating with the network application to receive the network application's current version. Here session module 118 determines the network application's version and the session state's version.

If block 806 determines that they are the same, the tools (e.g., session module 118) pass the session state to the network application (block 810).

If block 806 determines that the version of the session state is older than that of the network application, the tools upgrade the session state (block 812). The tools may act to upgrade the session state through an upgrade module or module(s) (not shown). Thus, if the version of the session state is 2.1 and the network application is 2.3, the tools may pass the session state to a module capable of upgrading the version to 2.2 and then to another module capable of upgrading the version to 2.3. Once the versions of the session state and network application are the same (or substantially similar so that the network application is capable of understanding the session state), the tools may pass the upgraded session state to the network application. This may enable the network application to be upgraded without requiring that current, existing session states be rendered unusable or their sessions ended. A network administrator, for instance, may be able to add a software patch to a network application or otherwise upgrade it without causing client's existing sessions to be stopped or rendered useless.

If block 806 determines that the version of the session state is newer than that of the network application, the tools upgrade the network application (or downgrade the session state). This may be downgrade with a downgrade session state module (not shown) or an upgrade network application module (also not shown), according to various well-known techniques.

The techniques of process 800 do not require that the session state or its version be stored in a BLOB or structure such as data structure 130, this is given as an example only.

Requests Not Needing a Session State

In some situations a request does not need a session state. A user may have an ongoing session and make a request to interact with a network application where the interaction does not need session-state continuity. If a user has an ongoing session with a particular session state for an address form, as mentioned above, and then wishes to get stock quotes from another application, for instance, this request may not need any session state.

A server system, however, may assume that the request may need a session state. If it does, the server system may make an unnecessary roundtrip in an attempt to fetch this session state. This roundtrip can waste system resources.

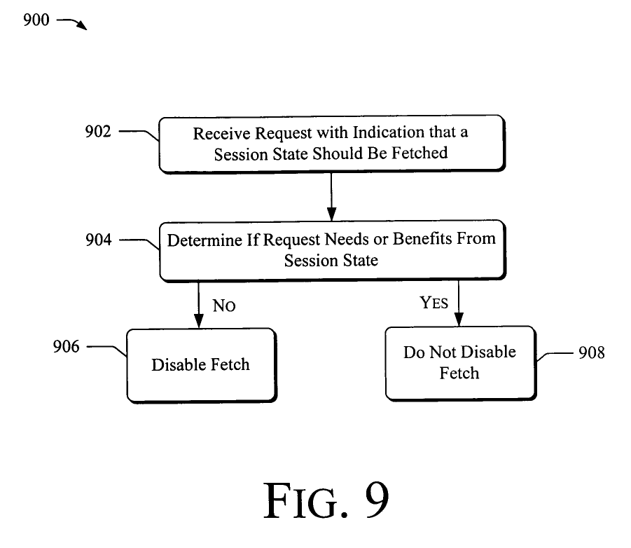

FIG. 9 is an exemplary process 900 enabling a system to avoid a roundtrip attempting to fetch a session state. It is illustrated as a series of blocks representing individual operations or acts performed by elements of operating environment 100 of FIG. 1, such as session stripper 126. This process may act in conjunction with or separate from other processes described herein.

Block 902 receives a request having an indication that a session state should be fetched. Block 902 may receive this request from an element in a server system. Here session stripper 126 receives a request from session module 118, 19 where the request has been assigned a session identifier or some other identifier causing the session module or some other element to perform a roundtrip in an attempt to fetch a session state.

Block 904 determines whether or not the request needs or would benefit from a session state being fetched. If not, the tools proceed to block 906. If so, the tools proceed to block 908. In one embodiment, block 904 determines this based in part on the network application being requested. If the network application never uses session states, such as a stock price ticker might not, block 904 determines that the request would not benefit from a session state. Block 904 may also determine this based on a URL received with the request, such as one indicating a particular webpage that does not use session states.

Block 906 disables a fetch attempting to gain a session state. Assume that session module 118 receives a request having a session state identifier or that session module 118 assigns a session state identifier to the request. Session stripper 126 may strip away the session state identifier. By so doing, other elements (or the session module) may be disabled from performing a roundtrip to fetch the session state. Following this, the request may be sent to the network application without a session state.

Block 908 does not disable the fetch attempting to gain a session state. Here the tools determine that the session state may be useful and so do not disable the fetch.

Embedding Session Information in Post-Back Data

Some server systems assign identifiers or otherwise associate information with a client or its requests with cookies or URLs. But some clients do not accept cookies or certain types of URLs.

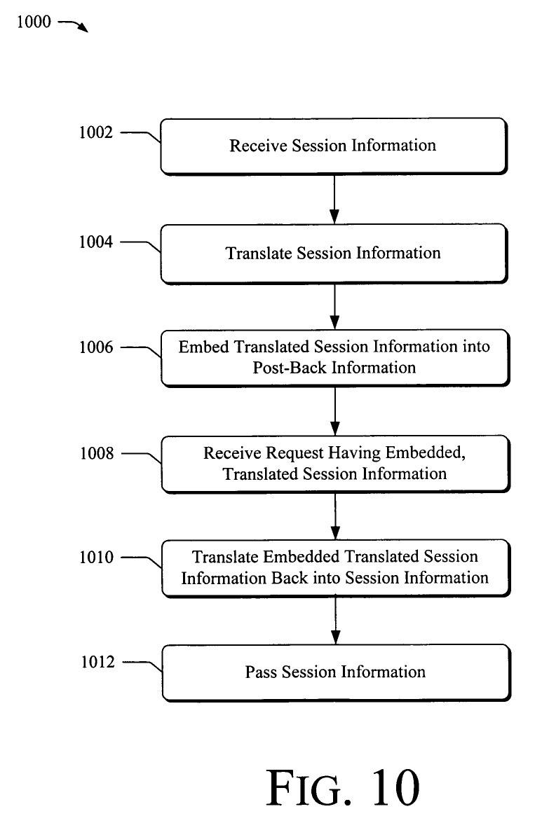

FIG. 10 is an exemplary process 1000 enabling a server system to associate information and/or assign identifiers to a client or client request without a cookie or URL. It is illustrated as a series of blocks representing individual operations or acts performed by elements of operating environment 100 of FIG. 1, such as post-back module 122. This process may act in conjunction with or separate from other processes described herein.

Process 1000 instead embeds information in post-back data sent to the client. This enables the client to forgo using cookies or URLs while still enabling the server system to determine a session or session state for a request later received from the client. In one embodiment the server system and the network application embed the general identifier along with the view information, rather than store it an a cookie or the URL, when the client itself will not accept the cookie or URL.

Block 1002 receives session information intended to be sent to a client. This session information may be a session identifier or the like, such as a general identifier assigned in process 200 and being passed to the client along with view information (blocks 204 and 214). Here post-back module 122 intercepts the general identifier and view information being sent to the client. The general identifier can be of various forms, such as a string or encoded integer. Note that the server(s) and network application(s) may pass the general identifier without needing any knowledge of or ability to work with another form for the information. This is enabled in part by the post-back module acting between session module 118 and client 102.

Block 1004 translates the session information. Here the post-back module translates the general identifier 302 of FIG. 3 into a form capable of being inserted into post-back information, such as a control compatible with view information also being sent to the client.

Block 1006 embeds the translated session information into the post-back information. Here the general identifier is translated into a control and embedded into the view information. If the view information is HTML, for example, the control may comprise HTML code for a hidden control. This embedded information is included, in some interpretable form, in future requests from the client.

Block 1008 receives a request from a client having the embedded information. Here post-back module 122 receives the request just prior to session module 118 so that the post-back module may translate the embedded session information back into a form usable by the session module.

Block 1010 translates the embedded information into a form interpretable by the server system and/or network application, such as the original form of the session information received at block 1002. This general identifier may then be analyzed as set forth in processes 6, 7, 8, or 9, as well as in ways well-known in the art.

Block 1012 then passes the session information to the server system. The server system (here session module 118 of environment 100) proceeds to use the session information. Here the post-back module passes general identifier 302 that usable by session module 118 and network application 120.

Enabling an Entity to be Brought down without Data Loss

A network entity, such as a server or application, may need to be brought down, such as to replace the server, upgrade the application, and the like. The tools provide a system and method enabling the entity to be brought down without losing data.

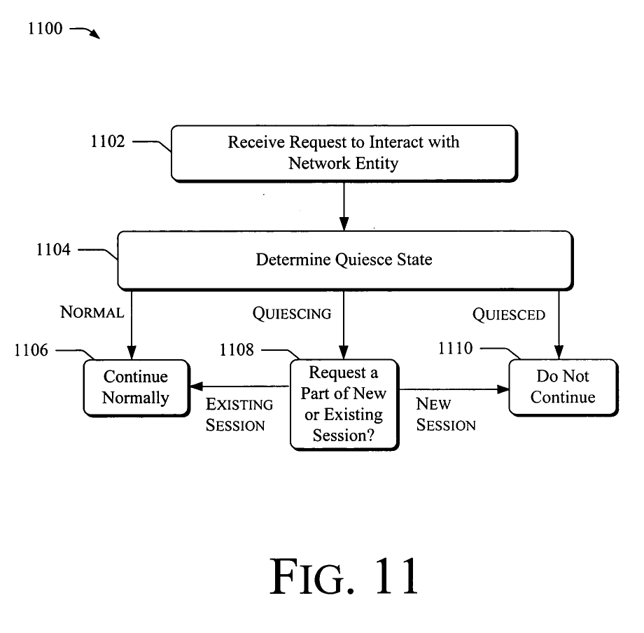

FIG. 11 is an exemplary process 1100 enabling a network entity to be brought down without data loss. It is illustrated as a series of blocks representing individual operations or acts performed by elements of operating environment 100 of FIG. 1, such as session module 118. This process may act in conjunction with or separate from other processes described herein.

Block 1102 receives a request to interact with a network entity. The request may be to interact with an application, an application instance, a server, or many servers, for instance. The request can be directed to a particular server or application or instead be directed to a server system that then directs the request to the particular server or application.

Block 1104 determines a quiesce state for the entity. The quiesce state is one indicating whether the server or application, for instance, is receiving new sessions, not receiving new sessions but still continuing existing sessions, or not receiving and not having any sessions. These are called, respectively, Normal State, Quiescing State, and Quiesced State.

These states may be stored in a data structure indicating an entity's configuration. The data structure may be accessible using an Application Program Interface (API).

If block 1104 determines that the state of the entity is Normal, the tools proceed to block 1106. Block 1106 proceeds normally to initiate a new session or session state or continue an existing session or session state. Thus, if the server and application are Normal, additional analysis may not be needed.

If block 1104 determines that the state of the entity is Quiescing, block 1104 proceeds to block 1108. Block 1108 determines the type of request. If block 1108 determines that the request is not part of an existing session (e.g., is a new or initial session), block 1108 proceeds to block 1110. Block 1108 may also determine that the request is part of an existing session or does not need a new session (a “subsequent request”).

Block 1110 does not initiate or prohibits a new session. Block 1110 is also performed if block 1104 determines that the state of the server or application is Quiesced.

If block 1108 determines that the request is part of an existing session, it proceeds to block 1106. Alternatively, block 1108 may, even if the request is part of an existing session with the entity, proceed to block 1110. In these cases a lock-out period is set. Thus, if sessions have been going too long (e.g., 12 hours), the tools may close all sessions down.

Process 1100 may apply to a server, servers, or application, such as server 112a, server(s) 112, or one of network application(s) 120, respectively. It may also apply to particular instances of a network application, such as a particular electronic form governed by a network application having multiple forms. If a request is specific to a network application that can be serviced at multiple servers, then the primary factor considered is the network application's state. If a request is specific to a particular server, then the primary factor considered is the server's state. If a request is specific to a network application and a server (such as for a server being dedicated to the network application or vice-versa), the state of both the network application and its server may be considered.

### CONCLUSION

The above-described systems and methods enable application-specific session states in a single session, a network entity to be brought down without data loss, additional privacy for session states, continuity when a session state's version differs from that of the session state's network application, and cessation of unnecessary roundtrips attempting to fetch session states. These and other techniques described herein may provide significant improvements over the current state of the art, potentially providing greater usability of server and server systems, reduced bandwidth costs, and an improved client experience with network-enabled applications. Although the system and method has been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

1. A computer-readable media having a computer-readable data structure, the data structure, when read by a computer, enabling session states for multiple applications or application instances to be accessed as part of a single session, the data structure comprising a single binary large object (BLOB) and two or more application identifiers, each application identifier indicating a portion of the BLOB having a session state for a network-enabled application.

2. The media of claim 1, wherein each application identifier is stored as a namespace in the BLOB.

3. The media of claim 1, the data structure further comprising a session identifier indicating the single session in which the session states are a part.

4. The media of claim 3, the data structure further comprising a client token indicating a user or client associated with the single session.

5. The media of claim 1, wherein the data structure further comprises a version identifier indicating a version of the session state in one of the portions of the BLOB.

6. The media of claim 1, wherein two or more of the application identifiers indicate portions of the BLOB having session states for a same network-enabled application but different instances of the same network-enabled application.

7. The media of claim 1, wherein two or more of the application identifiers indicate portions of the BLOB having session states for different network-enabled applications, each of the different network-enabled applications not capable of understanding the other application's session state.

8. The media of claim 1, wherein the BLOB is serialized with the application identifiers.

9. A computer-implemented method comprising:
receiving session information indicating a session between a client and a network-enabled application;
translating the session information to provide translated session information; and
embedding the translated session information into post-back information from the network-enabled application that is intended for use by the client.

10. The method of claim 9, wherein the session information is part of a cookie or universal resource locator and the translated session information is not part of a cookie or universal resource locator.

11. The method of claim 9, wherein the session information comprises a client token associated with the client and capable of differentiating the client from other clients.

12. The method of claim 9, wherein the session information comprises an application identifier associated with the network application and capable of differentiating the network application from other network applications.

13. The method of claim 9, wherein the post-back information comprises view information and the act of embedding embeds the translated session information as a control in the view information.

14. The method of claim 9, further comprising receiving a request from the client having the translated session information and further comprising translating the translated session information to provide second session information in a form interpretable by the network application or a server associated with the network application.

15. A computer-implemented method comprising:
receiving an initial or subsequent request to interact with a network entity, the initial request necessitating a new session with the network entity and the subsequent request not necessitating a new session with the network entity;
determining a state for the network entity;
permitting the initial or subsequent request if the state permits new sessions; and
permitting the request if it is a subsequent request and not permitting the request if it is an initial request if the state permits continuation of exiting sessions but not new sessions.

16. The method of claim 15, further comprising determining whether the state indicates that the network entity does not have any existing sessions and is not accepting any new sessions.

17. The method of claim 16, further comprising bringing the network entity down without loss of a session state.

18. The method of claim 15, wherein the network entity comprises a server.

19. The method of claim 15, wherein the network entity comprises a network-enabled application and the session comprises a session state.

20. The method of claim 15, wherein the network entity comprises an instance of a network-enabled application and the session comprises a session state for the instance.
